(19) United States
(12) Patent Application Publication
(10) Pub. No.: US 2022/0144682 A1
(43) Pub. Date: May 12, 2022

(54) ADDITIVE MANUFACTURING SYSTEM, METHOD, AND ARTICLE

(71) Applicant: CORNING INCORPORATED, CORNING, NY (US)

(72) Inventors: Charles Thomas McLaren, Elmira, NY (US); Aniello Mario Palumbo, Painted Post, NY (US); Thomas Matthew Sonner, Corning, NY (US)

(21) Appl. No.: 17/429,992

(22) PCT Filed: Jan. 29, 2020
(86) PCT No.: PCT/US2020/015601

§ 371 Date: Aug. 11, 2021

Related U.S. Application Data
(60) Provisional application No. 62/805,049, filed on Feb. 13, 2019.

(51) Int. Cl. C03B 19/01; B33Y 30/00; B33Y 10/00; B33Y 40/20; B33Y 80/00

(52) U.S. Cl. CPC C03B 19/01; B33Y 30/00; B33Y 50/02; B33Y 40/20; B33Y 80/00; B33Y 10/00

(57) ABSTRACT

A glass article manufacturing system 20 includes a crucible 44. The crucible 44 includes a barrel 52 and a nozzle 60. The barrel receives a feedstock. A translational stage 92 is positioned below the nozzle of the crucible. The translational stage is movable. A heater 72 is in thermal communication with the nozzle such that thermal energy provided by the heater is transferred to the feedstock. A feeder assembly 32 is positioned proximate the barrel of the crucible such that the feeder assembly feeds the feedstock into the barrel. The translational stage may provide negative pressure to retain a build plate to the translational stage. A preformed component may be positioned on the translational stage.

### CROSS-REFERENCE TO RELATED APPLICATION

This application claims the benefit of priority under 35 U.S.C. § 119 of U.S. Provisional Application Ser. No. 62/805,049 filed on Feb. 13, 2019, the content of which is relied upon and incorporated herein by reference in its entirety.

### FIELD OF THE DISCLOSURE

The present disclosure generally relates to additive manufacturing systems, and more specifically, to an additive manufacturing system for forming glass articles.

### BACKGROUND

Commonly available additive manufacturing techniques such as stereolithography of a resin filled with glass particles, or direct laser sintering of glass particles may have difficulty creating a part with excellent optical transparency because the glass particles may be difficult to sinter to full density. One additive manufacturing technique used for plastics, known as fused deposition modeling (FDM), has the advantage of using fiber as the feedstock, rather than a powder. In the FDM systems, fibers are pulled into a heated zone using a tractor wheel. Use of FDM with brittle glass fibers in place of the flexible plastic fibers results in broken fibers. In addition, it is not always possible to pull a fiber of the desired glass composition as the viscosity curve of flexible glass fibers is not always compatible with the fiber draw process. Conventional extrusion techniques may also be equally unsuited for additive manufacturing of glass products as extrusion is designed for larger diameters, and may require too high a temperature and pressure to produce a glass bead diameter of a desired size. Another method to lay down a thin bead of glass is to melt glass in a crucible with a hole at the bottom. However, as the diameter of the glass stream decreases, the stability of the stream decreases as well, and the flow stream may spiral and buckle.

### SUMMARY OF THE DISCLOSURE

According to at least one aspect of the present disclosure, a glass article manufacturing system includes a crucible. The crucible includes a barrel and a nozzle. The barrel receives a glass feedstock. A translational stage is positioned below the nozzle of the crucible. The translational stage is movable in an X-axis, a Y-axis, and a Z-axis. A heater is in thermal communication with the nozzle such that thermal energy provided by the heater is transferred to the glass feedstock. The heater heats the glass feedstock proximate the nozzle to form a melt pool of glass. A feeder assembly is positioned above the barrel of the crucible such that the feeder assembly feeds the glass feedstock into the barrel.

According to another aspect of the present disclosure, a glass article manufacturing system includes a crucible. The crucible includes a barrel and a nozzle. The barrel receives a glass feedstock. A translational stage is positioned below the nozzle of the crucible. The translational stage is movable in an X-axis, a Y-axis, and a Z-axis. The translational stage is provided with a vacuum retention portion. A heater is in thermal communication with the nozzle such that thermal energy provided by the heater is transferred to the glass feedstock. A feeder assembly is positioned above the barrel of the crucible such that the feeder assembly feeds the glass feedstock into the barrel.

According to another aspect of the present disclosure, a glass article manufacturing system includes a crucible. The crucible includes a barrel and a nozzle. The barrel receives a glass feedstock. A translational stage is positioned below the nozzle of the crucible. The translational stage is movable in an X-axis, a Y-axis, and a Z-axis. A heater is in thermal communication with the nozzle such that thermal energy provided by the heater is transferred to the glass feedstock. A feeder assembly is positioned above the barrel of the crucible such that the feeder assembly feeds the glass feedstock into the barrel. A preformed component of an article is positioned on the translational stage. Molten glass from the glass feedstock is extruded through the nozzle and onto the preformed component of an article.

According to another aspect of the present disclosure, a method of operating a glass article manufacturing system includes the steps of heating a glass feedstock within a crucible that includes a nozzle, extruding the glass feedstock through an aperture of the nozzle as a bead onto a preformed component of an article, and manipulating a translational stage in at least one of an X-axis, a Y-axis, and a Z-axis.

These and other features, advantages, and objects of the present disclosure will be further understood and appreciated by those skilled in the art by reference to the following specification, claims, and appended drawings.

### BRIEF DESCRIPTION OF THE DRAWINGS

The following is a description of the figures in the accompanying drawings. The figures are not necessarily to scale, and certain features and certain views of the figures may be shown exaggerated in scale or in schematic in the interest of clarity and conciseness.

FIG. 1 is a front view of an additive manufacturing system, according to one example;

FIG. 2 is front view of the additive manufacturing system, illustrating a relationship between a feeder assembly, a crucible, and a feedstock, according to one example;

FIG. 3 is a side view of the additive manufacturing system, illustrating the relationship between the feeder assembly, the crucible, and the feedstock, according to one example;

FIG. 4 is a front view of the additive manufacturing system, illustrating a relationship between the crucible, a furnace, and a translational stage, according to one example;

FIG. 5 is a cross-section of the crucible, taken along a vertical plane of the crucible, illustrating a flange, a barrel, a knuckle, and a nozzle, according to one example;

FIG. 6 is a front view of the additive manufacturing system, illustrating the translational stage within the furnace, according to one example;

FIG. 7 is a front view of the additive manufacturing system, illustrating a preformed component of an article upon the translational stage, according to one example;

FIG. 8 is a front view of the additive manufacturing system, illustrating extrusion of the feedstock onto the preformed component of an article, according to one example;

FIG. 9 is a side perspective view of a glass article produced by the additive manufacturing system, according to one example;

FIG. 10 is a flow diagram of a method of operating the additive manufacturing system, according to one example; and

FIG. 11 is a flow diagram of a method of operating the additive manufacturing system, according to another example.

### DETAILED DESCRIPTION

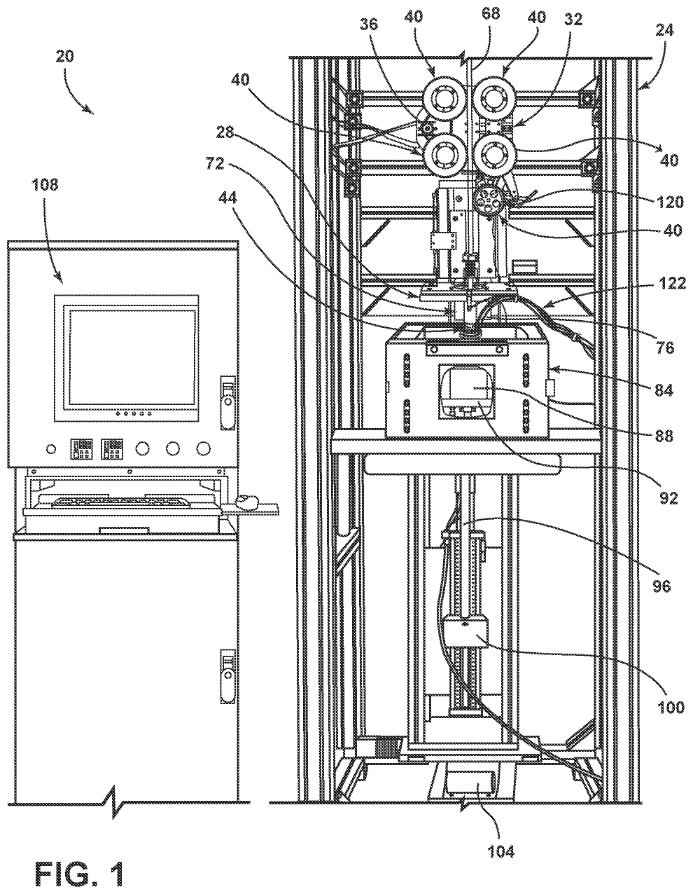

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an additive manufacturing system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

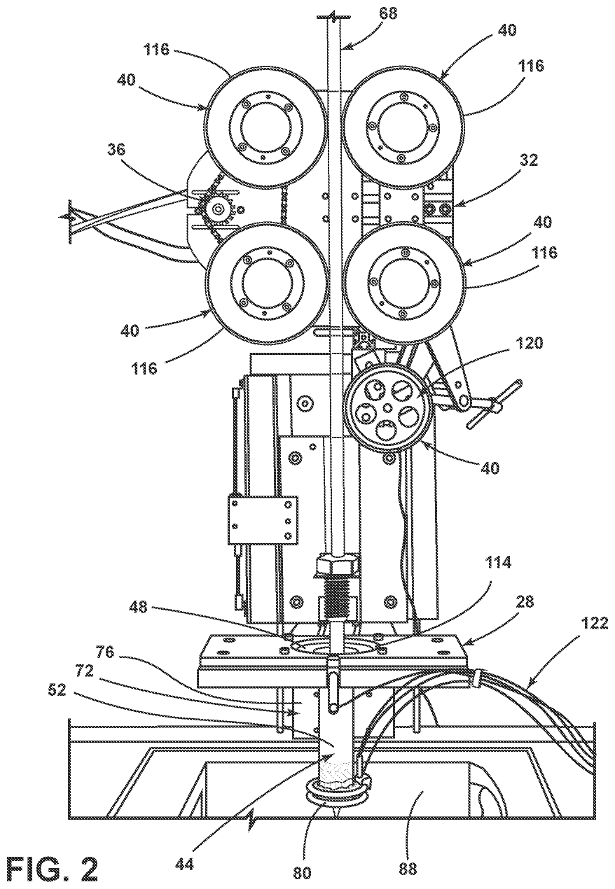

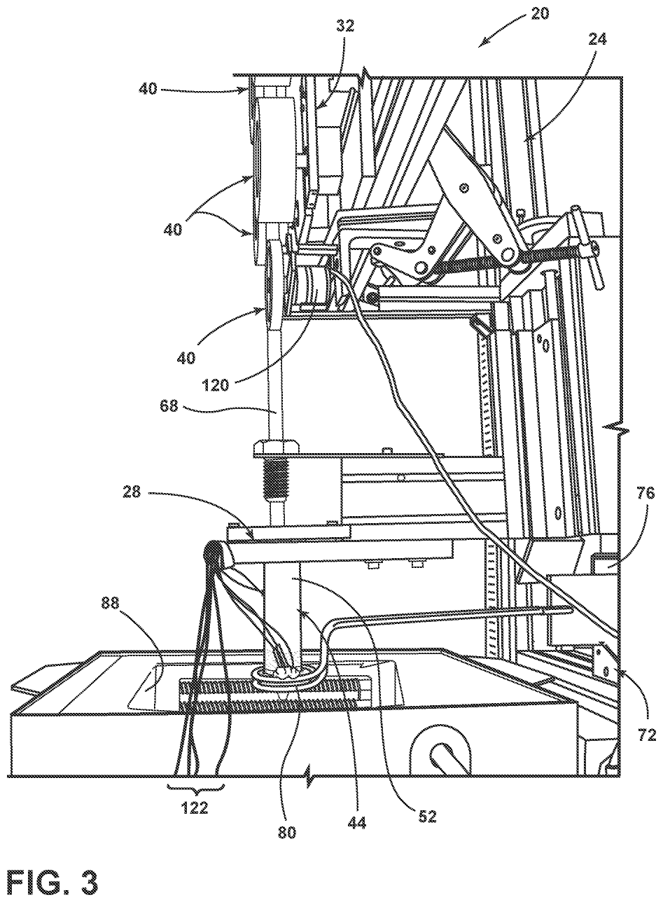

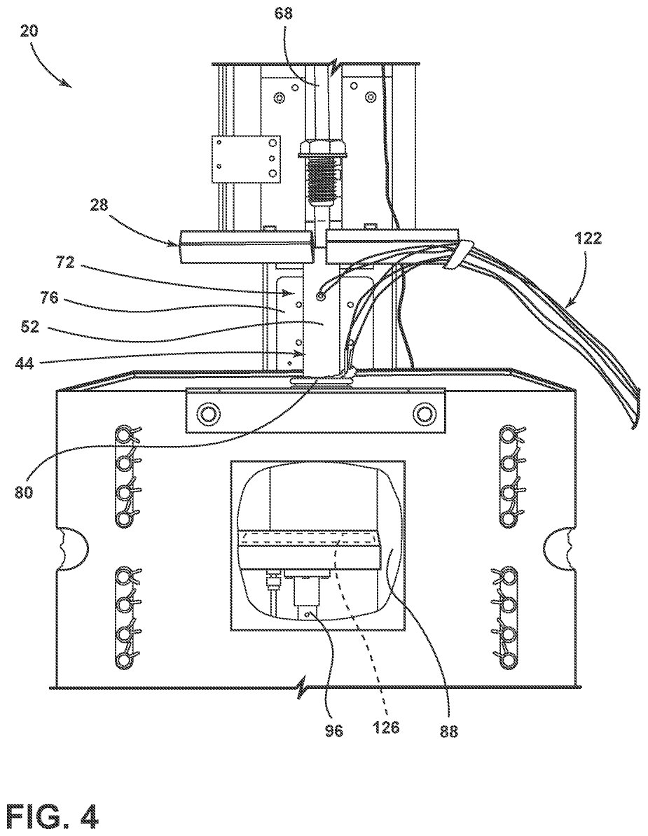

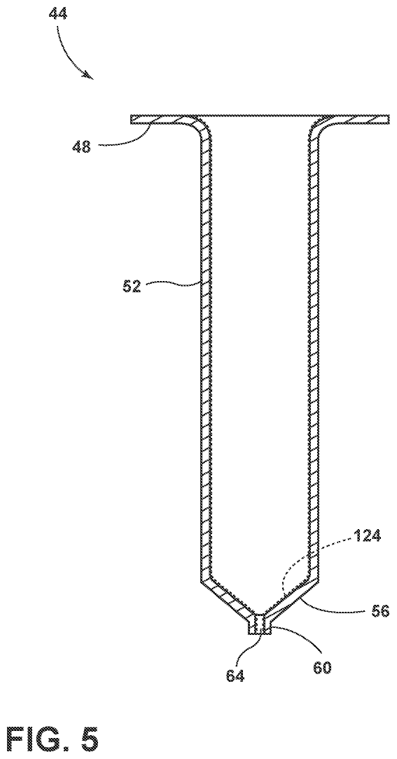

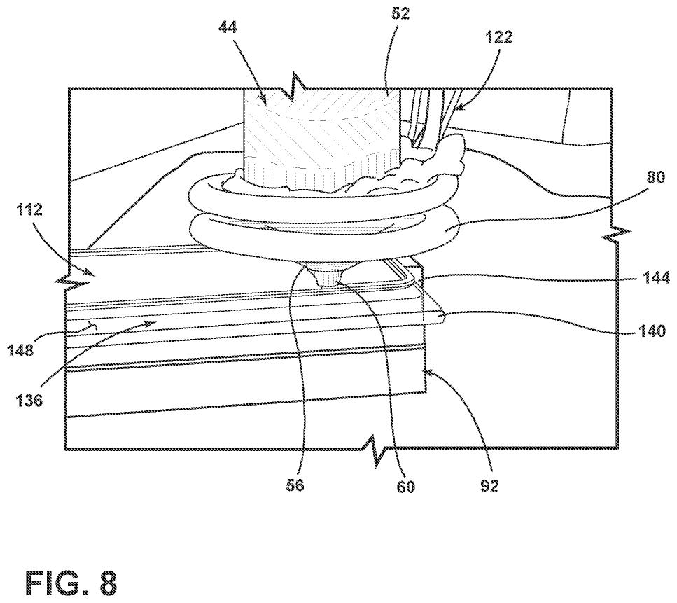

Referring to FIGS. 1-8, depicted is an additive manufacturing system 20 for making glass articles, among other components. In some examples, the system 20 may be referred to as a glass article manufacturing system 20. The system 20 includes a support structure 24 including an adapter 28. In the depicted example, a feeder assembly 32 is positioned towards a top of the support structure 24. The feeder assembly 32 includes one or more motors 36 (e.g., one or more servo motors). The feeder assembly 32 further includes one or more rollers 40. Each of the one or more rollers 40 may be driven by one of the one or more motors 36. Alternatively, one of the one or more motors 36 may drive a plurality of the rollers 40. In some examples, one or more of the one or more rollers 40 may be a passive roller that is not actively driven by one of the one or more motors 36. Positioned below the feeder assembly 32 is a crucible 44. The crucible 44 includes a flange 48, a barrel 52, a knuckle 56, a nozzle 60, and an aperture 64. The crucible 44 may be held to the support structure 24 by the adapter 28. Positioned within the crucible 44 is a feedstock 68. The system 20 further includes a heater 72. The heater 72 includes an induction unit 76 and an induction coil 80. A furnace 84 is supported by the support structure 24. The furnace 84 defines a cavity 88 into which the crucible 44 extends.

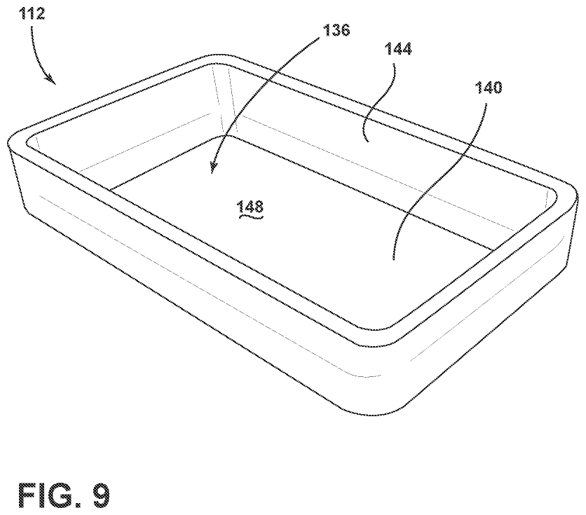

A translational stage 92 is positioned inside the cavity 88 of the furnace 84. The translational stage 92 is supported by a support rod 96. The support rod 96 is operably coupled to a Z-stage 100. The Z-stage 100 is configured to move the translational stage 92 within the cavity 88 of the furnace 84 in a Z-direction, such as along a vertical plane. The support structure 24 is coupled to an XY-stage 104. The Z-stage 100 and the XY-stage 104 are configured to move the translational stage 92 with respect to the crucible 44. It will be understood that the translational stage 92 and the furnace 84 may be arranged in a variety of configurations that allow movement relative to one another without departing from the teachings provided herein. For example, the translational stage 92 and/or the furnace 84 may move circularly, cylindrically, or in similar movements as defined by Cartesian or polar coordinates. As will be explained in greater detail below, the additive manufacturing system 20 includes a controller 108 that is configured to regulate a feed rate of the feeder assembly 32, the heat provided by the heater 72 to the crucible 44 (i.e., and the feedstock 68), the movement of the translational stage 92 and/or the crucible 44 relative to each other, and the temperature of the furnace 84 to form a glass article 112 (see FIG. 9).

The support structure 24 is configured to hold various components of the system 20 in place during operation. In some examples, the support structure 24 may include a linear slide to which the feeder assembly 32 and/or the adapter 28 are coupled such that the crucible 44 and/or the feeder assembly 32 may be adjusted in the Z-direction. The adapter 28 may include a groove 114 to permit seating of the flange 48 of the crucible 44 to the adapter 28. Insulators may be included on both sides of the flange 48 within the adapter 28 while ensuring proper seating of the crucible 44 within the support structure 24. In some examples, these insulators may be washers or fiber blankets composed of a ceramic or polymeric material in order to provide electrical isolation to the crucible 44. Further, the insulators may provide thermal insulation between the support structure 20 and the crucible 44.

Positioned above the crucible 44 is the feeder assembly 32. It will be understood that the positional relationship between the feeder assembly 32 and the crucible 44 may be changed depending on the glass article 112 intended to be made. For example, the crucible 44 and the feeder assembly 32 may be positioned substantially at the same height such that the feedstock 68 is actuated in a substantially horizontal direction. The feeder assembly 32 is configured to deliver or feed the feedstock 68 into the barrel 52 of the crucible 44. In one specific example, the rollers 40 of the feeder assembly 32 are rotated in a counter-rotating manner such that the feedstock 68 is advanced in the direction of the barrel 52 of the crucible 44. A circumferential surface of the rollers 40 may be provided with a coating 116 or otherwise provided with padding and/or gripping materials to aid in handling of the feedstock 68. For example, the circumferential surface of the rollers 40 may be provided with a rubberized coating that provides a degree of padding or compliance to the feedstock 68, as well as an increased coefficient of friction with the feedstock 68. One of the rollers 40 may be provided with, or referred to as, a velocity encoder 120 that registers and/or provides a linear velocity of the feedstock 68 as the feedstock 68 is advanced toward the crucible 44. Dimensional information can be provided to the controller 108 about the feedstock 68, such as diameter and/or length, from which the controller 108 may determine a rate at which to advance the feedstock 68 by referencing a desired or predetermined rate of extrusion. For example, the radius and/or circumference of the roller 40 associated with the velocity encoder 120 may be known, as well as at least a diameter of the feedstock 68. The controller 108 may obtain a rate of rotation from the velocity encoder 120, calculate a rate of linear advancement of the feedstock 68 from known dimensions of the roller 40 associated with the velocity encoder 120, and reference the calculated rate of advancement of the feedstock 68 toward the crucible 44 against a desired or otherwise predetermined target rate of advancement, which may be defined as a range of advancement rates. In one specific example, the controller 108 may monitor a calculated volume-in of the feedstock 68 into the crucible 44 and/or a measured or calculated volume-out of extruded feedstock 68. The target volume-in of the feedstock 68 may be 5 cubic millimeters per second (mm³/s), 10 cubic millimeters per second (mm³/s), 15 cubic millimeters per second (mm³/s), 20 cubic millimeters per second (mm³/s), 25 cubic millimeters per second (mm³/s), 30 cubic millimeters per second (mm³/s), 35 cubic millimeters per second (mm³/s), 40 cubic millimeters per second (mm³/s), and/or combinations or ranges thereof. The target volume-out of the feedstock 68 may be substantially similar to the target volume-in of the feedstock 68. For example, the target volume-out of the feedstock 68 may be within two-percent (2%), five-percent (5%), and/or ten-percent (10%) of the target volume-in of the feedstock 68. Target linear velocities of the feedstock 68 may be at least five micrometers per second (5 μm/s), at least ten micrometers per second (10 μm/s), at least fifty micrometers per second (50 μm/s), at least one hundred micrometers per second (100 μm/s), at least two hundred micrometers per second (200 μm/s), and/or combinations or ranges thereof.

According to various examples, the feedstock 68 may include one or more glasses and glass materials. The feedstock 68 may be formed as a rod having a diameter greater than or equal to about 1 mm, 20 mm, 30 mm, 40 mm, 50 mm, 100 mm, or larger than about 125 mm in diameter. A rod may be distinguished from a filament with respect to the thickness and the compressive force it may withstand, as a rod is thicker than a filament and may withstand a greater compressive force. For example, while a filament may be flexible at room temperature, the rod example of the feedstock 68 may not be flexible at room temperature such that a force applied by the feeder assembly 32 does not result in damage or deformation of the feedstock 68. It will be understood that the diameter of the rod of the feedstock 68 may be adjusted based on the desired size of the glass article 112 to be made. Further, the diameter of the feedstock 68 may be different over the length of the feedstock 68. In other examples, the feedstock 68 may be composed of a plurality of rods (e.g., a bundle), a powder, a plurality of filaments, a plurality of disks (e.g., wafers or patties of the rods), a plurality of particles, a plurality of beads and/or combinations thereof.

As explained above, the feedstock 68 may be formed of a glass or glass material. The glass or glass material of the feedstock 68 may include Pyrex®, quartz, aluminum silicate glasses, soda-lime glass, an aluminosilicate glass, an alkali-aluminosilicate glass, a borosilicate glass, an alkali-borosilicate glass, an aluminoborosilicate glass, an alkali-aluminoborosilicate glass, a fused silica glass, glasses resistant to high thermal shock, glasses with high working ranges, colored glasses, doped glasses, transparent glasses, translucent glasses, opaque glasses and combinations thereof. It will be understood that the composition of the feedstock 68 may change or vary over the length of the feedstock 68. For example, multiple different rods of different compositions of glass may be loaded into the crucible 44 such that at different points during extrusion of the feedstock 68 onto the translational stage 92, different compositions of glass are formed. Such an example may be advantageous in forming a glass article 112 having different regions of different composition.

According to various examples, the glass of the feedstock 68 may have a long working range. The working range of the glass is defined as the range of temperatures that correspond to the point where the glass begins to soften to the point where the glass is too soft to control. In other words, the working range is the range of temperatures at which the viscosity of the feedstock 68 is sufficiently low enough to extrude, but not low enough as too melt and drip out of the nozzle 60. Selection of the glass composition for the feedstock 68 may be guided by choosing a glass with a viscosity curve, or working range, which does not result in a burdensome amount of temperature change to affect viscosity. Further, care should be taken during the selection of the glass composition to select a glass with a viscosity curve not so sensitive to temperature change that wide changes in viscosity occur over a short temperature range (e.g., less than 100° C., less than 50° C., less than 10° C.). In other words, when selecting a glass composition for the feedstock 62, the composition should not be difficult to heat to a flowing state, but should also not be difficult to maintain in either a flowing state or a solid state. Glass compositions that include nodes in the viscosity change (i.e., drastic viscosity changes over a small temperature range) may be advantageous for various start and stop and sequences of the system 20. The working range of the feedstock 68 may be greater than or equal to about 100° C., 150° C., 200° C., 275° C., 300° C., 350° C. or greater than about 500° C. In some examples, the feedstock 68 can be heated to 1000° C., 1200° C., 1400° C., 1600° C., 1700° C., and/or combinations or ranges thereof. For example, the feedstock 68 may be heated to a temperature within the range of 1400° C.-1600° C., such as a temperature within the range of 1450° C.-1575° C. When heated to the operating temperature of the system 20, the feedstock 68 may exhibit a viscosity of less than 5000 poise, less than 4000 poise, less than 3000 poise, less than 2000 poise, less than 1000 poise, less than 800 poise, greater than 600 poise, and/or combinations or ranges thereof.

The crucible 44 receives the feedstock 68. As explained above, the crucible 44 includes the flange 48, the barrel 52, the nozzle 60, and defines the aperture 64. The barrel 52 may have an inside diameter greater than or equal to about 10 mm, 20 mm, 30 mm, 34 mm, 40 mm, 50 mm, 100 mm, 200 mm or 500 mm. The barrel 52 may have a thickness of greater than or equal to about 1 mm, 2 mm, 5 mm, 10 mm, 25 mm, or 50 mm. It will be understood that the thickness of the barrel 52 may be any practicable thickness for supporting the feedstock 68, withstanding pressures experienced by the crucible 44, and withstanding temperatures provided by the heater 72. In various examples, the crucible 44 may be capable of withstanding temperatures greater than 600° C., greater than 800° C., greater than 1000° C., greater than 1200° C., greater than 1400° C., greater than 1600° C., greater than 1700° C., less than 1800° C., less than 1900° C., less than 2000° C. and/or combinations or ranges thereof without damaging, deforming, or otherwise rendering the crucible 44 unsatisfactory for its intended use. The aperture 64 may be positioned at the bottom of the crucible 44 such that the feedstock 68, when heated (e.g., melted or otherwise heated to its working temperature), may be extruded therefrom. The aperture 64 may have an inside diameter of less than or equal to about 500 mm, 125 mm, 25 mm, 3 mm, 1.5 mm, 0.5 mm, or less than about 0.1 mm. It will be understood that the diameter of the aperture 64 may be altered depending on the size of the glass article 112 (e.g., larger aperture 64 for a larger glass article 112 to decrease manufacturing time) or based on a desired bead size of the feedstock 68 extruded through the aperture 64.

The ratio between the inside diameter of the barrel 52 (e.g., an entrance to the nozzle 60) and the aperture 64 may be greater than or equal to about 1, 1.5, 5, 10, 20 or 50. The nozzle 60 may define the aperture 64 as a variety of shapes including circular, square, triangular, star patterned, or other desired shapes of the bead of extruded feedstock 68. Further, the nozzle 60 may be dynamic such that the size and/or shape of the aperture 64 may change throughout a process run of the system 20. For example, the aperture 64 may begin with a substantially circular shape, but may be changed to a rectangular shape or a triangular shape part way through the process run and then optionally returned back to a circular shape. Further, the nozzle 60 may include a mandrel configured to extrude the feedstock 68 as a tube or other hollow structure. A plurality of thermocouples 122 may be attached or otherwise coupled to the crucible 44 through the nozzle 60, the knuckle 56, and the barrel 52 to measure the temperature of the feedstock 68 passing through the crucible 44 at different points.

The crucible 44 may be formed of a conductive metal such as platinum, rhodium, steel, stainless steel, and other metals with a melting temperature sufficiently above the working range of the feedstock 68. In a specific example, the crucible 44 may be formed of an 80 weight percent (wt. %) platinum and 20 wt. % rhodium alloy. The crucible 44 may be formed of metal with a melting point greater than a softening point of the feedstock 68. Metals of the crucible 44 may also be selected based on the reactivity of the metal with the glass. For example, metals that are not reactive with the feedstock 68 may be used. Reactivity between the feedstock 68 and the material of the crucible 44 may include the transfer of ions or elements between the feedstock 68 and the material of the crucible 44 to a point at which either the feedstock 68 and/or crucible 44 is unsuitable for its intended purpose (e.g., a property or characteristic changes).

Additionally or alternatively, the crucible 44 may include one or more inserts 124 positioned between the barrel 52 and the feedstock 68. The inserts 124 may be formed of a different material than the crucible 44. The inserts 124 may take the form of a separate component inserted into the crucible 44 and/or take the form of a film or coating deposition on interior surfaces of the crucible 44. Use of such inserts 124 may be advantageous in broadening the materials that may be used for the crucible 44 (e.g., metals which otherwise may be reactive with the feedstock 68) by separating contact between the feedstock 68 and the material of the crucible 44. For example, the crucible 44 can be made of stainless steel and the insert 124 or film positioned on the inside of the crucible 44 may be a platinum rhodium alloy with low reactivity to the feedstock 68. The metal selected for the crucible 44 may also be selected based on a creep resistance property. As the temperature of the crucible 44 increases, the environment that the crucible 44 is exposed to may result in a strain of the crucible 44. Accordingly, materials having a high creep resistance, or low susceptibility to strain when under force at high temperatures, may be utilized for the crucible 44.

According to various examples, at the beginning of a process run of the system 20, the first rod of feedstock 68 inserted into the crucible 44 may be machined such that an exterior surface of the feedstock 68 substantially matches an interior surface of the nozzle 60 of the crucible 44 such that heat may be more efficiently transferred from the crucible 44 to the feedstock 68. Such a machining of the feedstock 68 may lessen the amount of time necessary to begin producing the glass article 112.

As explained above, the additive manufacturing system 20 includes the heater 72. The heater 72 includes the induction unit 76 and the induction coil 80. The induction unit 76 is configured to provide alternating current to the induction coil 80 such that the induction coil 80 may inductively heat the crucible 44. In other words, the heater 72 is in thermal communication with the nozzle 60 of the crucible 44. The heat of the crucible 44 is then transferred to the feedstock 68 to heat the feedstock 68. The amount of power provided by the induction unit 76 may be altered during a process run of the additive manufacturing system 20 based on desired characteristics of the feedstock 68 as it is extruded into the glass article 112. The induction coil 80 is depicted as surrounding the knuckle 56 of the crucible 44, but it will be understood that the induction coil 80 may be positioned in a number of locations along the length of the crucible 44. Further, multiple induction coils 80 may be utilized along the crucible 44 in order to heat various locations of the feedstock 68. Use of the induction coil 80 may be advantageous in providing nearly instantaneous control of the temperature of the crucible 44 and the feedstock 68. In some examples, a heat-transfer material may be provided between the crucible 44 and the induction coil 80 to provide direct contact between the crucible 44 and the induction coil 80 while maintaining a tolerance distance that allows for expansion of the crucible 44 upon heating. It will be understood that the induction unit 76 and the induction coil 80 of the heater 72 may be replaced by other forms of heating the crucible 44. For example, the heater 72 may be used in conjunction with, or replaced by, a flame heat system, an infrared heating system, a resistance coil heating system (e.g., a nichrome wrap) and other forms of heating.

In the depicted example, the furnace 84 is positioned below the crucible 44. The crucible 44 extends into the cavity 88 of the furnace 84. It will be understood that the crucible 44 may extend into the furnace 84 or the aperture 64 may be coplanar with an entrance of the furnace 84. The furnace 84 may be sealed at a top and a bottom to keep a heated environment within the furnace 84. The cavity 88 of the furnace 84 may be filled with an inert gas (e.g., non-reactive to the glass article 112 or the feedstock 68) or may be filled with typical atmospheric gases. The furnace 84 may keep a temperature sufficiently high to anneal the glass article 112 but lower than the working temperature of the feedstock 68. The temperature of the furnace 84 may be sufficiently high to keep the extruded glass article 112 pliable, but not high enough to allow sag in the article 112. In some examples, the furnace 84 may be provided with one or more windows through which the progress of the production of the glass article 112 may be monitored. The windows may be apertures cut from sides of the furnace 84, the furnace 84 may define the apertures, and/or viewing panes may be provided in the apertures such that the interior of the furnace 84 may be viewed while maintaining a generally closed environment to the furnace 84.

The translational stage 92 is positioned within the cavity 88 of the furnace 84. It will be understood that the translational stage 92 may be replaced with any build surface or substrate. As explained above, the translational stage 92 is positioned within the furnace 84 to accept or receive the extruded glass feedstock 68. It will be understood that a component (e.g., a mechanical and/or electrical part) may be placed on the translational stage 92 and receive the feedstock 68 such that the glass article 112 is a subcomponent of a larger component. For example, the component may be a preformed component of an article (e.g., the glass article 112) that receives the feedstock 68 such that a completed article results. The completed article may be a near net shape or near final dimension product that does not require substantial post-processing. The support rod 96 extends from a bottom of the translational stage 92, through the cavity 88, and out of the furnace 84. The support rod 96 is coupled with the Z-stage 100 such that the translational stage 92 may be raised and lowered in the Z-direction. Further, the support structure 24 is coupled with the XY-stage 104 such that the nozzle 60 and the translational stage 92 may be moved in the X-, Y-, and Z-directions relative to each other. According to at least one alternative example, the support structure 24 may be coupled to the Z-stage 100 and the XY-stage 104 such that the controller 108 may regulate movement of the crucible 44 relative to the translational stage 92. Such an example may be advantageous for the production of large glass articles 112 (i.e., such that the large glass article 112 does not have to be moved). In another alternative example, the translational stage 92 may be coupled to the Z-stage 100 and the XY-stage 104 such that the controller 108 may regulate movement of the translational stage 92 relative to the crucible 44. Such an example may be advantageous for the production of smaller glass articles 112 (i.e., because the relatively larger support structure 24 may remain stationary). Even further, all or some of the system 20 may be positioned within the furnace 84 for the production of large glass articles 112.

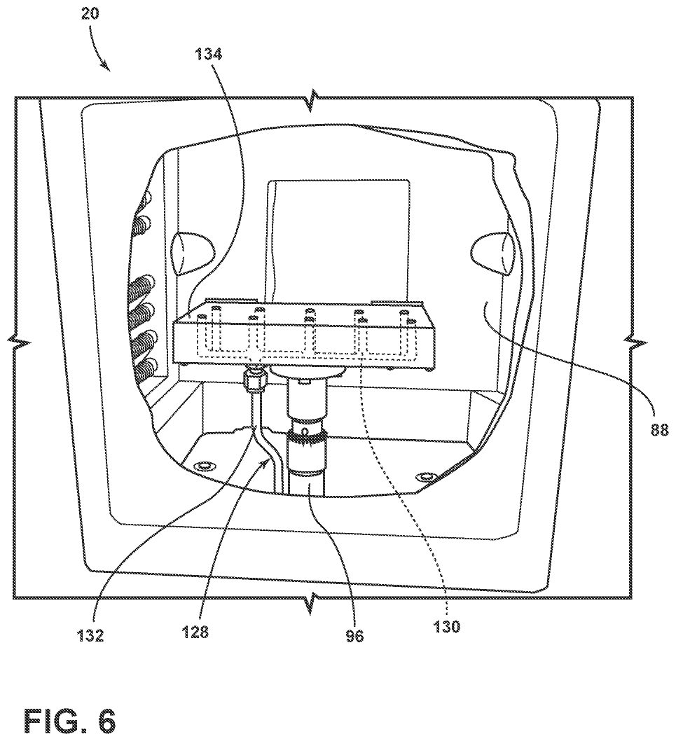

According to some examples, a heating element 126 (FIG. 6) may be positioned on a bottom of the translational stage 92. The heating element 126 may extend over all or a portion of the translational stage 92. The heating element 126 may be configured to heat all of or just a portion of the translational stage 92 (i.e., to form hot and cold zones on the translational stage 92). As such, the translational stage 92 may form a heated build surface. Such hot and cold zones may be advantageous in manufacturing the glass article 112 to have different properties throughout its structure. Heating of the translational stage 92 by the heating element 126 may decrease a thermal shock experience by the glass article 112 as the feedstock 68 is extruded from the crucible 44. Use of the heating element 126 may be advantageous in examples of the additive manufacturing system 20 not incorporating the furnace 84 or in examples where the furnace 84 is kept at a lower temperature. It will be understood that in commercial examples of the system 20, the translational stage 92 may be a portion of a conveyor belt or other assembly line component configured to mass-produce the glass articles 112. In such an example, the crucible 44 may be configured to move relative to the translational stage 92.

In operation of the system 20, the controller 108 is configured to instruct the feeder assembly 32 to exert a force on the feedstock 68 to move the feedstock 68 into the crucible 44. As the crucible 44 is heated, the heat is transferred to the feedstock 68. The feedstock 68 is heated to a temperature within its working range such that the feedstock 68 may begin to flow through the aperture 64 of the nozzle 60. As such, the feedstock 68 is extruded through the nozzle 60 of the crucible 44. The feedstock 68 may be heated proximate the knuckle 56 and the nozzle 60, but also at points throughout the barrel 52. The feedstock 68 exits the nozzle 60 as a continuous bead of material. The feedstock 68 then contacts the translational stage 92, or a preformed component of an article, and begins to “set up,” or cool as it is extruded. In other words, as the feedstock 68 contacts the translational stage 92, or the preformed component of an article, the feedstock 68 cools and increases in viscosity until the feedstock 68 solidifies.

After the bead of feedstock 68 contacts the translational stage 92, or the preformed component of an article, the translational stage 92 may begin to move in a three-dimensional (3D) manner using the Z-stage 100 and/or the XY-stage 104. As explained above, additionally or alternatively, the crucible 44 may be moved relative to the translational stage 92 86 (e.g., for the production of large glass articles 112). As the translational stage 92 is moved relative to the nozzle 60, the bead of feedstock 68 begins to extend through space (i.e., and solidify as it goes) to form the glass article 112. In other words, the feedstock 68 solidifies as it is extruded such that the glass article 112 maintains the shape generated by the relative motion of the translational stage 92 and the nozzle 60. At an end point of the glass article 112, the controller 108 controls the heater 72 to stop heating of the crucible 44 which in turn returns the feedstock 68 to a temperature lower than its working range. The relatively quick reduction of the temperature of the feedstock 68 and crucible 44, in addition to a removal of the force that may have been applied by the feeder assembly 32, causes the feedstock 68 to suck back into the nozzle 60 due to a negative pressure. Further, the feeder assembly 32 may pull back on the feedstock 68 resulting in the feedstock 68 being sucked back into the nozzle 60. Such a quick temperature shift and recoiling of the feedstock 68 back into the nozzle 60 may help starting and stopping the material flow, and reducing or eliminating “hairs,” or fine strands of material extending away from the glass article 112 toward the nozzle 60, at the article's end point. Further, a rapid motion by the nozzle 60 at the end of the run (relative to the formed glass article's end point), in addition to the change in temperature and/or pressure, may remove hairs from an end point of the glass article 112. The controller 108 may control the feeder assembly 32 and the translational stage 92 in concert to create the glass article 112 from a single continuous bead of feedstock 68, from a plurality of beads of feedstock 68 laid on one another, or combinations thereof. At hotter temperatures of extrusion and/or of the furnace 84, the beads of feedstock 68 may merge into a seamless, optically transparent, multilayer structure.

Referring further to FIGS. 1-8, in various examples, the system 20 includes the crucible 44, which includes the barrel 52 and the nozzle 60. The barrel 52 receives the feedstock 68, which may be a glass feedstock. In the depicted examples, the translational stage 92 is positioned below the nozzle 60 of the crucible 44. However, the present disclosure is not so limited, as discussed above. The translational stage 92 can be movable in at least one of an X-axis, a Y-axis, and a Z-axis. The heater 72 is in thermal communication with the nozzle 60 such that thermal energy provided by the heater 72 is transferred to the feedstock 68. In various examples, the heater 72 heats the feedstock 68 that is proximate the nozzle 60 to form a melt pool (e.g., a melt pool of glass). The melt pool is distinguished from a softened state of the feedstock 68. For example, the melt pool may be accomplished by heating the crucible 44 and/or the feedstock 68 to a temperature that is greater than a temperature range associated with a softening zone of the feedstock 68. The melt pool can enable printing or extrusion at lower viscosities of the feedstock 68 when compared to feedstocks 68 heated to their softening zone. In some examples, molten portions of the feedstock 68, such as the melt pool, can be extruded out of the nozzle 60 by at least one of gravity, hydrodynamic pressure, and viscosity of the molten feedstock 68 (e.g., glass viscosity for glass feedstocks). The feeder assembly 32, in the depicted examples, is positioned above the barrel 52 of the crucible 44 such that the feeder assembly 32 feeds the feedstock 68 into the barrel 52. In various examples, the controller 108 is configured to generate one or more movement instructions for the system 20 based on input data related to a three-dimensional shape of an article to be produced. For example, the controller 108 can be configured to generate one or more movement instructions for the translational stage 92 based on input data related to a three-dimensional shape of the article that is desired or will be produced. However, it is contemplated that the nozzle 60 may be moved relative to the translational stage 92 rather than the translational stage 92 being moved relative to the nozzle 60, or a combination of movement of the nozzle 60 and movement of the translational stage 92 may be utilized in the production of the article. In various examples, the input data related to the three-dimensional shape of the article can be a computer-aided design (CAD) file and the movement instructions generated by the controller 108 (e.g., for the translational stage 92) can be a G-code file. In some examples, the translational stage 92 can include a vacuum retention portion 128. The vacuum retention portion 128 may include channels 130 defined by the translational stage 92 and a delivery line 132. The vacuum retention portion 128 of the translational stage 92 can provide a negative pressure to at least a portion of a surface 134 of the translational stage 92 such that a build plate can be retained to the translational stage 92. In various examples, the negative pressure provided by the vacuum retention portion 128 can be 0 kPa, −5 kPa, −10 kPa, −15 kPa, −20 kPa, −25 kPa, −30 kPa, and/or combinations or ranges thereof. The build plate that is retained to the translational stage 92 can be a preformed component of an article 136. In some examples, the preformed component of an article 136 can be an article that is a display-quality piece of glass. In various examples, the glass article 112 produced by the system 20 can include a base portion 140 and a raised portion 144. The raised portion 144 can extend away from a surface 148 of the base portion 140. For example, the raised portion 144 may extend vertically away from the surface 148 of the base portion 140. In various examples, the base portion 140 may be the preformed component of an article 136 and the raised portion 144 may be the feedstock 68 that was extruded from the system 20. Alternatively, the base portion 140 may be a portion of the feedstock 68 that was extruded prior to the extrusion of the raised portion 144. Said another way, the base portion 140 may be extruded or printed prior to the extrusion or printing of the raised portion 144 in terms of a time domain (i.e., chronologically). In various examples, the glass article 112 can be substantially transparent. In some examples, the base portion 140 and the raised portion 144 can be integrated with one another in a seamless, or near-seamless, manner.

Referring again to FIGS. 1-8, in some examples, the system 20 includes the crucible 44, which includes the barrel 52 and the nozzle 60. The barrel 52 receives the feedstock 68, which may be a glass feedstock. In the depicted examples, the translational stage 92 is positioned below the nozzle 60 of the crucible 44. However, the present disclosure is not so limited, as discussed above. The translational stage 92 can be movable in at least one of an X-axis, a Y-axis, and a Z-axis. In various examples, the translational stage 92 can be provided with the vacuum retention portion 128. The vacuum retention portion 128 of the translational stage 92 can provide a negative pressure to at least a portion of the surface 134 of the translational stage 92 such that the build plate can be retained to the translational stage 92. In various examples, the negative pressure provided by the vacuum retention portion 128 can be 0 kPa, −5 kPa, −10 kPa, −15 kPa, −20 kPa, −25 kPa, −30 kPa, and/or combinations or ranges thereof. In various examples, the build plate retained to the translational stage 92 can be the preformed component of an article 136. In some examples, the preformed component of an article 136 can be a display-quality piece of glass. The heater 72 is in thermal communication with the nozzle 60 such that thermal energy provided by the heater 72 is transferred to the feedstock 68. The feeder assembly 32, in the depicted examples, is positioned above the barrel 52 of the crucible 44 such that the feeder assembly 32 feeds the feedstock 68 into the barrel 52. In various examples, the heater 72 heats the feedstock 68 that is proximate the nozzle 60 to form a melt pool (e.g., a melt pool of glass). The melt pool is distinguished from a softened state of the feedstock 68. For example, the melt pool may be accomplished by heating the crucible 44 and/or the feedstock 68 to a temperature that is greater than a temperature range associated with a softening zone of the feedstock 68. The melt pool can enable printing or extrusion at lower viscosities of the feedstock 68 when compared to feedstocks 68 heated to their softening zone. In some examples, molten portions of the feedstock 68, such as the melt pool, can be extruded out of the nozzle 60 by at least one of gravity, hydrodynamic pressure, and viscosity of the molten feedstock 68 (e.g., glass viscosity for glass feedstocks). In some examples, the controller 108 is configured to generate one or more movement instructions for the system 20 based on input data related to a three-dimensional shape of an article to be produced. For example, the controller 108 can be configured to generate one or more movement instructions for the translational stage 92 based on input data related to a three-dimensional shape of the article that is desired or will be produced. However, it is contemplated that the nozzle 60 may be moved relative to the translational stage 92 rather than the translational stage 92 being moved relative to the nozzle 60, or a combination of movement of the nozzle 60 and movement of the translational stage 92 may be utilized in the production of the article. In various examples, the input data related to the three-dimensional shape of the article can be a computer-aided design (CAD) file and the movement instructions generated by the controller 108 (e.g., for the translational stage 92) can be a G-code file. In various examples, the glass article 112 produced by the system 20 can include the base portion 140 and the raised portion 144. The raised portion 144 can extend away from the surface 148 of the base portion 140. For example, the raised portion 144 may extend vertically away from the surface 148 of the base portion 140. In various examples, the base portion 140 may be the preformed component of an article 136 and the raised portion 144 may be the feedstock 68 that was extruded from the system 20. Alternatively, the base portion 140 may be a portion of the feedstock 68 that was extruded prior to the extrusion of the raised portion 144. Said another way, the base portion 140 may be extruded or printed prior to the extrusion or printing of the raised portion 144 in terms of a time domain (i.e., chronologically). In various examples, the glass article 112 can be substantially transparent. In some examples, the base portion 140 and the raised portion 144 can be integrated with one another in a seamless, or near-seamless, manner.

Referring further to FIGS. 1-8, in various examples, the system 20 includes the crucible 44, which includes the barrel 52 and the nozzle 60. The barrel 52 receives the feedstock 68, which may be a glass feedstock. In the depicted examples, the translational stage 92 is positioned below the nozzle 60 of the crucible 44. However, the present disclosure is not so limited, as discussed above. The translational stage 92 can be movable in at least one of an X-axis, a Y-axis, and a Z-axis. The heater 72 is in thermal communication with the nozzle 60 such that thermal energy provided by the heater 72 is transferred to the feedstock 68. The feeder assembly 32, in the depicted examples, is positioned above the barrel 52 of the crucible 44 such that the feeder assembly 32 feeds the feedstock 68 into the barrel 52. The preformed component of an article 136 can be positioned on the translational stage 92, where molten portions of the feedstock 68 (e.g., molten glass feedstock) is extruded through the nozzle 60 and onto the preformed component of an article 136. In various examples, the translational stage 92 can include the vacuum retention portion 128. The vacuum retention portion 128 of the translational stage 92 can provide a negative pressure to at least a portion of the surface of the translational stage 92 such that the build plate can be retained to the translational stage 92. In various examples, the negative pressure provided by the vacuum retention portion 128 can be 0 kPa, −5 kPa, −10 kPa, −15 kPa, −20 kPa, −25 kPa, −30 kPa, and/or combinations or ranges thereof. In various examples, the build plate retained to the translational stage 92 can be the preformed component of an article 136. In some examples, the preformed component of an article 136 can be a display-quality piece of glass. In some examples, the heater 72 can heat the feedstock 68 (e.g., the glass feedstock) proximate the nozzle 60 to form the melt pool of the feedstock 68 (e.g., a glass melt pool). In various examples, formation of the melt pool may be accomplished by heating the crucible 44, the feedstock 68, and/or the melt pool to a temperature greater than a softening zone of the feedstock 68. Molten portions of the feedstock 68, which are provided by the melt pool, can be extruded out of the nozzle 60 by at least one of gravity, hydrodynamic pressure, and viscosity of the melt pool. In various examples, the controller 108 is configured to generate one or more movement instructions for the system 20 based on input data related to a three-dimensional shape of an article to be produced. For example, the controller 108 can be configured to generate one or more movement instructions for the translational stage 92 based on input data related to a three-dimensional shape of the article that is desired or will be produced. However, it is contemplated that the nozzle 60 may be moved relative to the translational stage 92 rather than the translational stage 92 being moved relative to the nozzle 60, or a combination of movement of the nozzle 60 and movement of the translational stage 92 may be utilized in the production of the article. In various examples, the input data related to the three-dimensional shape of the article can be a computer-aided design (CAD) file and the movement instructions generated by the controller 108 (e.g., for the translational stage 92) can be a G-code file. In various examples, the glass article 112 produced by the system 20 can include the base portion 140 and the raised portion 144. The raised portion 144 can extend away from the surface 148 of the base portion 140. For example, the raised portion 144 may extend vertically away from the surface 148 of the base portion 140. In various examples, the base portion 140 may be the preformed component of an article 136 and the raised portion 144 may be the feedstock 68 that was extruded from the system 20. Alternatively, the base portion 140 may be a portion of the feedstock 68 that was extruded prior to the extrusion of the raised portion 144. Said another way, the base portion 140 may be extruded or printed prior to the extrusion or printing of the raised portion 144 in terms of a time domain (i.e., chronologically). In various examples, the glass article 112 can be substantially transparent. In some examples, the base portion 140 and the raised portion 144 can be integrated with one another in a seamless, or near-seamless, manner.

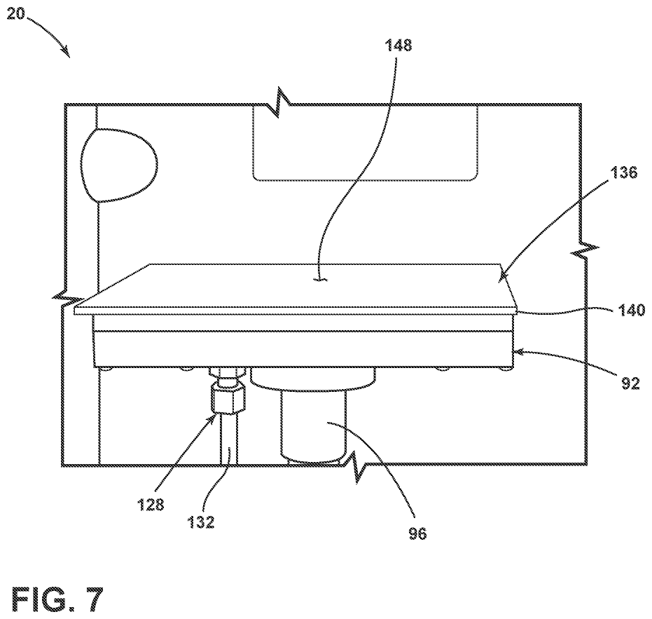

Referring now to FIGS. 7-9, depicted is an example of the glass article 112 as manufactured by the system 20. According to various examples, the glass article 112 may be substantially transparent and/or colorless. The glass article 112 may have a transparency greater than about 60%, 70%, 80%, 90%, or greater than about 99% for visible light. The glass article 112 is composed of one or more beads extruded proximate one another to form the glass article 112. For example, the glass article 112 may include a single bead extending through a three-dimensional space or a single or multiple beads stacked on one another.

Conventional additive manufacturing systems often utilize one or more fugitive materials to form a support structure. The fugitive material may be etched, melted, and/or burned away after formation of the article to form the self-supporting angle α. The presently disclosed system 20 may be capable of forming articles without the use of fugitive materials and/or a support structure. The glass article 112 may exhibit bends, or changes of direction, of less than about 135°, 90°, 45°, 10° or less than about 1°. It will be understood that a bend or change in direction of the glass article 102 may be between about 0.1° and about 359°.

In examples, the glass article 112 may be formed of a plurality of glass beads arranged in a stack to form the three-dimensional glass article 112. In such an example, each bead may be fused to an adjacent bead. It will be understood that although described as a plurality of beads, the glass article 112 may be formed from a single continuous bead folded or guided back onto its self. The beads may be fused to one another over the length of the beads or at a plurality of points. In such examples, the glass article 112 may be substantially transparent through the stack of fused beads. As explained above, the beads of extruded feedstock 68 may flow into crevices formed between adjacent beads that may enhance the transparency of the glass article 112 (e.g., due to elimination of air voids between the beads). Further, the glass article 112 may define one or more voids within the glass article 112 formed through placement of the beads of feedstock 68. As explained above, by positioning, or dragging, the nozzle 60 in a previously laid bead of the feedstock 68, the stack-up tolerance of the glass article 112 may be minimized with respect to conventional glass additive manufacturing techniques. The glass article 112 may take a variety of configurations. For example, the glass article 112 may form a glass encapsulation device (e.g., for electronic devices), a flow reactor, or a nose cone with conformal cooling channels. The glass article 112 may be substantially or completely bubble free and may be of a complex design. As explained above, the composition of the glass article 112 may vary across the stack (i.e., in multiple bead or stacked single bead examples) and/or across individual beads.

A variety of advantages may be obtained using the disclosure provided herein. First, the additive manufacturing system 20 may produce a glass article 112 which is substantially transparent, bubble free and of a complex design. Second, use of the furnace 84 may prevent a thermally induced curl in the glass article 112 and may prevent the glass article 112 from undergoing a thermal shock. Third, complex designs, including tubes, may be formed in the glass article 112. Fourth, the improved starts/stop control of the system 20 results in increased consistency at an end point of the glass article 112 (e.g., a decrease in the production of “hairs”). A decrease in the presence of hairs may allow for a more aesthetically pleasing and complex article 112 to be formed. Fifth, the system 20 may extrude a bead of the feedstock 68 onto an existing component to form a glass portion of that component. Sixth, the composition and/or properties (e.g., color, transparency, resistance to thermal shock, etc.) of the feedstock 68 may be altered through the process run such that different portions of the glass article 112 exhibit different properties. Seventh, as the feedstock 68 is extruded and solidifies, molds and other conventional forming techniques for glass components may not be necessary, which may save manufacturing, time, cost, material, and machining. Eighth, the system 20 is scalable to produce glass articles 112 of nearly any size by changing the size of the crucible 44, nozzle 60, and/or feeder assembly 32. Ninth, use of the rod examples of the feedstock 68 instead of traditional filaments allows longer operating times between when the system 20 must be reloaded with more feedstock 68.

In various examples, the translational stage 92 may be replaced by a grasping assembly (e.g., a drill chuck, a clamping feature, a vise-like feature, etc.) that grasps a portion of the feedstock 68 with a compressive force. The grasping assembly may clamp down on extruded feedstock 68 that has exited the nozzle 60 and cooled to a rigid or solidified state. Once the cooled, extruded feedstock 68 has been grasped by the grasping assembly, the grasping assembly can be moved by the Z-stage 100 and/or the XY-stage 104 as additional feedstock 68 is extruded such that the extruded feedstock 68 takes on the shape and dimensions imparted by the movement of the grasping assembly. As the shape and/or dimensions are imparted by the movement of the grasping assembly, the extruded feedstock 68 begins to cool and become rigid, thereby retaining the structural relationship imparted by the movement of the grasping assembly. For example, uploaded CAD files may be converted to G-code by the controller 108, which in turn dictates the movements undertaken by the grasping assembly. Accordingly, the shape, structural relationships, and/or dimensions taken on by the extruded feedstock 68 can retain the shape dictated by the G-code and ultimately resemble the desired structure from the CAD file. Such a grasping assembly can enable extrusion of the feedstock 68 without using a stage or base plate that the extruded feedstock 68 is printed or extruded upon. Generating an extruded feedstock 68 article with the grasping assembly may be done at cooler crucible 44 temperatures than the crucible 44 temperatures utilized for printing or extruding onto the translational stage 92. For example, the crucible 44 temperature may be in the range of 1400° C. to 1500° C. Additionally, a printing or extrusion speed utilized while extruding the feedstock 68 by employing the grasping assembly may be slower than the printing or extrusion speed utilized when employing the translational stage 92. For example, the printing or extrusion speed utilized when employing the grasping assembly may be less than or equal to one millimeter per second (1 mm/s). The printing or extrusion speed utilized when employing the translational stage 92 may be greater than 1 mm/s, greater than 2 mm/s, greater than 3 mm/s, greater than 4 mm/s, greater than 5 mm/s, greater than 6 mm/s, greater than 7 mm/s, greater than 8 mm/s, greater than 9 mm/s, greater than 10 mm/s, greater than 11 mm/s, greater than 12 mm/s, greater than 13 mm/s, greater than 14 mm/s, greater than 15 mm/s, and/or combinations or ranges thereof. It is noted that print or extrusion speed may vary depending on a composition of the feedstock 68, a viscosity of the feedstock 68 when heated to the operating temperature, and/or a width of the bead or line being deposited. By extruding at a lower speed or rate with the grasping assembly examples, the feedstock 68 is allowed to at least partially cool and/or set-up such that the extruded article retains the structure imparted by the movements of the grasping assembly.

The support rod 96 may be provided with a coupling portion positioned between the support rod 96 and an underside of the translational stage 92. When a user desires to transition from using the translational stage 96 to using an alternative attachment (e.g., the grasping assembly), then the user may loosen or otherwise disengage the coupling portion from the translational stage 92 and/or the support rod 96. In one specific example, once the translational stage 96 is removed, the grasping assembly may be installed onto the support rod 96 (e.g., with the coupling portion). In some examples, the grasping assembly may be a drill chuck or a drill-chuck-like assembly, where grasping portions (e.g., grasping jaws or grasping fingers) can be actuated in a vertical direction and/or a horizontal direction. For example, the grasping portions may be moveable between retracted and extended positions. When in the retracted position, the grasping portions may be horizontally displaced from one another such that a space is defined between the grasping portions. When in the extended position, the grasping portions may be horizontally proximate, or close to, one another such that the space defined between the grasping portions has been decreased. Accordingly, the grasping portions may be actuated from the retracted position to an at least partially extended position to grasp the extruded feedstock 68 within the space defined by the grasping portions. Actuation of the grasping portions between the retracted position and the extended position may be accomplished by linear and/or rotational motion of at least a portion of the grasping assembly, similar to a drill chuck.

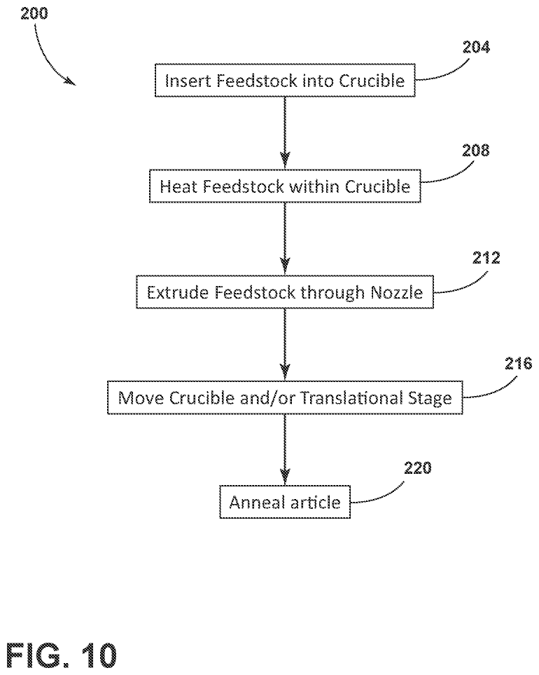

Referring now to FIG. 10, depicted is an exemplary method 200 of operating the additive manufacturing system 20 to produce the glass article 112 (FIG. 9). The method 200 begins with step 204 of inserting the feedstock 68 into the crucible 44 of the system 20. The feedstock 68 may be coupled to the feeder assembly 32 simultaneously or sequentially relative to step 204. Next, step 208 of heating the glass feedstock 68 within the crucible 44 is performed. As explained above, the heater 72 heats the crucible 44, which in turn heats the glass feedstock 68 within the crucible 44. The heater 72 heats the feedstock 68 to a sufficiently high temperature such that the feedstock 68 is within its working range.

Next, step 212 of extruding the glass feedstock 68 through the nozzle 60 onto the translational stage 92, or the preformed component of an article, is performed. In step 212, the feeder assembly 32 may apply sufficient force to the feedstock 68 such that the portion of the feedstock 68 heated to its working range is extruded through the nozzle 60 and onto the translational stage 92. Alternatively, the feedstock 68 may decrease in viscosity to the point that the feedstock 68 is extruded primarily by at least one of gravity, hydrodynamic pressure (e.g., from additional melting feedstock 68), and glass viscosity rather than active pressure applied by the feeder assembly 32. The feedstock 68 is extruded as a bead. The controller 108 may control the feeder assembly 32 to extrude a single, continuous, bead or a plurality of smaller beads of feedstock 68.

Next, step 216 of moving at least one of the crucible 44 and the translational stage 92 is performed. As explained above, the controller 108 is configured to regulate positional control of the crucible 44 and/or the translational stage 92 relative to one another. The controller 108 is configured to move the crucible 44 and/or the translational stage 92 as the feedstock 68 is extruded from the nozzle 60 to form the glass article 112. The controller 108 controls the position of the crucible 44 and/or translational stage 92 such that the bead(s) of feedstock 68 is/are placed on the translational stage 92, or the preformed component of an article, to build the glass article 112. While moving the crucible 44 and/or the translational stage 92, the controller 108 may be configured to drag the nozzle 60 through the previously applied bead of feedstock 68. The nozzle 60 may be dragged through the bead at a depth less than or equal to about half the thickness of the material layer being deposited. Dragging the nozzle 60 through the previously deposited bead of feedstock 68 may be advantageous in helping to smear the previously laid bead of feedstock 68 and create better adhesion between beads of feedstock 68 laid on top of one another. Better adhesion between the beads may result in tighter stack-up tolerances.

Next, step 220 of annealing the glass article 112 may be performed. Annealing of the glass article 112 may be performed in the furnace 84. The temperature and time at which the glass article 112 is annealed may be regulated by the controller 108.

In various examples, the method 200 can produce the glass article 112. The glass article 112 produced by the system 20 can include the base portion 140 and the raised portion 144. The raised portion 144 can extend away from the surface 148 of the base portion 140. For example, the raised portion 144 may extend vertically away from the surface 148 of the base portion 140. In various examples, the base portion 140 may be the preformed component of an article 136 and the raised portion 144 may be the feedstock 68 that was extruded from the system 20. Alternatively, the base portion 140 may be a portion of the feedstock 68 that was extruded prior to the extrusion of the raised portion 144. Said another way, the base portion 140 may be extruded or printed prior to the extrusion or printing of the raised portion 144 in terms of a time domain (i.e., chronologically). In various examples, the glass article 112 can be substantially transparent. In some examples, the base portion 140 and the raised portion 144 can be integrated with one another in a seamless, or near-seamless, manner.

It will be understood that the steps of the method 200 may be performed in any order, repeated, omitted, and/or performed simultaneously without departing from the teachings provided herein.

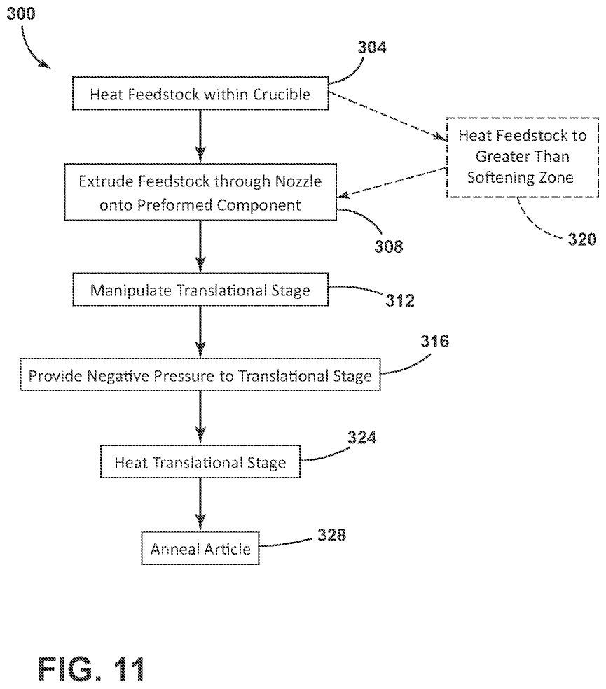

Referring to FIG. 11, depicted is an exemplary method 300 of operating the additive manufacturing system 20 to produce the glass article 112 (FIG. 9). The method 300 can include step 304 of heating the feedstock 68 (e.g., a glass feedstock) within the crucible 44 that includes the nozzle 60. Next, the method 300 can advance to step 308 of extruding the feedstock 68 (e.g., a glass feedstock) through the aperture 64 of the nozzle 60 as a bead onto the preformed component of an article 136. Then, simultaneously and/or sequentially, the method 300 can perform step 312 of manipulating the translational stage 92 in at least one of an X-axis, a Y-axis, and a Z-axis. In various examples, the method 300 can include step 316 of providing a negative pressure to the surface 134 of the translational stage 92 such that the preformed component of an article 136 is retained to the translational stage 92. In some examples, the step 304 of heating the feedstock 68 within the crucible 44 that includes the nozzle 60 can further include step 320 of heating the feedstock 68 to a temperature that is greater than the softening zone of the feedstock 68. In various examples, the method 300 can further include step 324 of heating the translational stage 92. In some examples, the method 300 can further include step 328 of annealing an article produced by operating the additive manufacturing system 20 (e.g., a glass article).

In various examples, the method 300 can produce the glass article 112. The glass article 112 produced by the system 20 can include the base portion 140 and the raised portion 144. The raised portion 144 can extend away from the surface 148 of the base portion 140. For example, the raised portion 144 may extend vertically away from the surface 148 of the base portion 140. In various examples, the base portion 140 may be the preformed component of an article 136 and the raised portion 144 may be the feedstock 68 that was extruded from the system 20. Alternatively, the base portion 140 may be a portion of the feedstock 68 that was extruded prior to the extrusion of the raised portion 144. Said another way, the base portion 140 may be extruded or printed prior to the extrusion or printing of the raised portion 144 in terms of a time domain (i.e., chronologically). In various examples, the glass article 112 can be substantially transparent. In some examples, the base portion 140 and the raised portion 144 can be integrated with one another in a seamless, or near-seamless, manner.

It will be understood that the steps of the method 300 may be performed in any order, repeated, omitted, and/or performed simultaneously without departing from the teachings provided herein.

In some examples, the first translational movement of the system 20, whether moving the crucible 44 or the translational stage 92, may be a wipe step. For example, as the feedstock 68 begins extrusion, the translational stage 92 may be moved into position proximate the nozzle 60 of the crucible 44. Then, the translational stage 92 may “wipe” the feedstock 68 that is exiting the nozzle 60 on an edge of the translational stage 92 and/or a region of the base portion 140 that is not intended for the final glass article 112. Next, the translational stage 92 may move underneath the nozzle 60 to a ready position where the feedstock 68 is extruded onto the base portion 140 at a region of the base portion 140 that is intended to be included in the final glass article 112. The wipe step allows the article that is being printed or extruded to be manufactured without an unintentionally large deposit, or gob, of extruded feedstock 68 material being deposited at the beginning of the printing or extrusion of the glass article 112. The unintentionally large deposit can manifest as a defect that requires removal and/or further processing of the finished glass article 112.

### Example

Depicted in FIG. 9 is an example of a glass structure (e.g., the glass article 112) produced using a three-dimensional glass printer (e.g., the system 20). As can be seen, the extruded feedstock 68 has adhered in a seamless manner to both the base portion 140 (e.g., the preformed component of an article 136) and the previously laid or extruded beads of the raised portion 144 during the production of the glass article 112. The structure is formed from a single, continuous, bead of glass through three-dimensional space that is printed onto the preformed component of an article 136. As deposition of the extruded feedstock 68 occurs, the layer thickness is determined by the distance between the nozzle 60 and the base portion 140 (or the previously extruded layer). In the depicted example, the width of the extruded layers was 3 mm and the thickness, or height, of the individual extruded layers was 1 mm. The width of the deposition layer is a function of linear velocity and glass flow rate from the crucible 44, with the thickness already having been defined by the position of the translational stage 92 relative to the nozzle 60. The finished glass article 112 is provided as a near net shape or near final dimension product. Accordingly, post-processing steps, such as grinding and polishing, are kept to a minimum without needing to remove large amounts of material. Instead, minor post-processing steps are executed such that the glass article 112 is within narrow dimensional tolerances and exhibits desirable optical and/or aesthetic properties. A feed material (e.g., feedstock 68) used by the printer was Pyrex® glass. In the depicted example, the preformed component of an article 136 is a display-quality piece of glass and the glass article 112 is produced as an enclosure for an electronic device (e.g., a smartphone, a tablet, a computer, or the like). By using a display-quality piece of glass, additional processing or machining time (e.g., polishing) can be reduced such that the base portion 140 need not be polished or further machined and only the raised portion 144 that was extruded undergoes further processing, thereby saving time, cost, and/or material when performing finishing work on the glass article 112. The components of the electronic device may be assembled within the glass article 112 and a top cover portion may close or otherwise seal the enclosure of the glass article 112 such that the assembled components of the electronic device are protected from intrusion of debris, liquid, and/or foreign material. Additionally, the enclosure may provide additional protection to the assembled components of the electronic device from shock (e.g., dropping) while providing a transparent or translucent rear surface (when held or viewed by a user) such that internal components may be viewed or various advertising and/or customization may be exhibited by the manufacturer, the provider, or the user.

Modifications of the disclosure will occur to those skilled in the art and to those who make or use the disclosure. Therefore, it is understood that the embodiments shown in the drawings and described above are merely for illustrative purposes and not intended to limit the scope of the disclosure, which is defined by the following claims, as interpreted according to the principles of patent law, including the doctrine of equivalents.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

1. A glass article manufacturing system, comprising:
a crucible comprising a barrel and a nozzle, wherein the barrel receives a glass feedstock;
a translational stage positioned below the nozzle of the crucible, the translational stage movable in an X-axis, a Y-axis, and a Z-axis;
a heater in thermal communication with the nozzle such that thermal energy provided by the heater is transferred to the glass feedstock; and
a feeder assembly positioned above the barrel of the crucible such that the feeder assembly feeds the glass feedstock into the barrel.

2. The glass article manufacturing system of claim 14, wherein the melt pool of glass is heated to a temperature greater than a softening zone of the glass feedstock.

3. The glass article manufacturing system of claim 2, wherein molten portions of the glass feedstock are extruded out of the nozzle by at least one of gravity, hydrodynamic pressure, and glass viscosity.

4. The glass article manufacturing system of claim 1, further comprising:
a controller that is configured to generate movement instructions for the translational stage based on input data related to a three-dimensional shape of an article.

5. The glass article manufacturing system of claim 4, wherein the input data related to the three-dimensional shape of the article is a CAD file, and wherein the movement instructions generated by the controller for the translational stage is a G-code file.

6. The glass article manufacturing system of claim 1, wherein the translational stage further comprises a vacuum retention portion.

7. The glass article manufacturing system of claim 6, wherein the vacuum retention portion of the translational stage provides a negative pressure to at least a portion of a surface of the translational stage such that a build plate can be retained to the translational stage.

8. The glass article manufacturing system of claim 7, wherein the build plate retained to the translational stage is a preformed component of an article.

9. The glass article manufacturing system of claim 8, wherein the preformed component of an article is a display-quality piece of glass.

10-13. (canceled)

14. The glass article manufacturing system of claim 1, wherein the heater heats the glass feedstock proximate the nozzle to form a melt pool of glass.

15-18. (canceled)

19. A glass article manufacturing system, comprising:
a crucible comprising a barrel and a nozzle, wherein the barrel receives a glass feedstock;
a translational stage positioned below the nozzle of the crucible, the translational stage movable in an X-axis, a Y-axis, and a Z-axis;
a heater in thermal communication with the nozzle such that thermal energy provided by the heater is transferred to the glass feedstock;
a feeder assembly positioned above the barrel of the crucible such that the feeder assembly feeds the glass feedstock into the barrel; and
a preformed component of an article positioned on the translational stage, wherein molten glass from the glass feedstock is extruded through the nozzle and onto the preformed component.

20. The glass article manufacturing system of claim 19, wherein the translational stage further comprises a vacuum retention portion.

21. The glass article manufacturing system of claim 20, wherein the vacuum retention portion of the translational stage provides a negative pressure to at least a portion of a surface of the translational stage such that a build plate can be retained to the translational stage.

22. The glass article manufacturing system of claim 21, wherein the build plate retained to the translational stage is the preformed component of an article.

23. The glass article manufacturing system of claim 19, wherein the preformed component of an article is a display-quality piece of glass.

24. The glass article manufacturing system of claim 19, wherein the heater heats the glass feedstock proximate the nozzle to form a melt pool of glass.

25. The glass article manufacturing system of claim 24, wherein the melt pool of glass is heated to a temperature greater than a softening zone of the glass feedstock.

26. The glass article manufacturing system of claim 25, wherein molten portions of the glass feedstock are extruded out of the nozzle by at least one of gravity, hydrodynamic pressure, and glass viscosity.

27. The glass article manufacturing system of claim 19, further comprising:
a controller that is configured to generate movement instructions for the translational stage based on input data related to a three-dimensional shape of a desired article.

28. The glass article manufacturing system of claim 27, wherein the input data related to the three-dimensional shape of the desired article is a CAD file, and wherein the movement instructions generated by the controller for the translational stage is a G-code file.

29. A method of operating a glass article manufacturing system, comprising the steps of:
heating a glass feedstock within a crucible comprising a nozzle;
extruding the glass feedstock through an aperture of the nozzle as a bead onto a preformed component of an article; and
manipulating a translational stage in at least one of an X-axis, a Y-axis, and a Z-axis.

30. The method of operating a glass article manufacturing system of claim 29, further comprising the step of:
providing a negative pressure to a surface of the translational stage such that the preformed component of an article is retained to the translational stage.

31. The method of operating a glass article manufacturing system of claim 29, wherein the step of heating a glass feedstock within a crucible comprising a nozzle further comprises the step of:
heating the glass feedstock to a temperature greater than the softening zone of the glass feedstock.

32. The method of operating a glass article manufacturing system of claim 29, further comprising the step of:
heating the translational stage.

33. The method of operating a glass article manufacturing system of claim 29, further comprising the step of:
annealing the glass article.

34. A glass article formed by the system of claim 1, comprising:
a base portion; and
a raised portion that extends away from a surface of the base portion.

35-36. (canceled)

37. A glass article formed by the method of claim 29, comprising:
a base portion; and
a raised portion that extends away from a surface of the base portion.

38. The glass article of claim 34, wherein the glass article is substantially transparent.

39. The glass article of claim 34, wherein the base portion and the raised portion are integrated in a seamless manner.
